(19) United States
(12) Patent Application Publication
(10) Pub. No.: US 2026/0101269 A1
(43) Pub. Date: Apr. 9, 2026

(54) AMBIENT POWER-ENABLED IOT DEVICE CONTEXT PURGE TRIGGERS

(71) Applicant: INTERDIGITAL PATENT HOLDINGS, INC., Wilmington, DE (US)

(72) Inventors: Mohamad Kenan Al-Hares, Canterbury (GB); Michael Starsinic, Newtown, PA (US); Guanzhou Wang, Brossard (CA); Anuj Sethi, Ottawa (CA); Samir Ferdi, Kirkland (CA)

(73) Assignee: INTERDIGITAL PATENT HOLDINGS, INC., Wilmington, DE (US)

(21) Appl. No.: 18/905,525

(22) Filed: Oct. 3, 2024

(51) Int. Cl. H04W 48/08; H04W 60/06; H04W 84/18

(52) U.S. Cl. CPC H04W 48/08; H04W 60/06; H04W 84/18

(57) ABSTRACT

Disclosed is a method for managing the context of an AIoT device at an AMF. The process starts when the Access and Mobility Management Function (AMF) receives an inventory request from an Application Function (AF), identifying the AIoT device and providing context preservation instructions. The AMF retrieves the device's subscription information and informs the AIoT device that it is the serving node. The AMF then creates and stores the device's context information to manage its connectivity within the network. To handle the inventory request, the AMF sends a request to the AIoT device via a base station and receives a response, which is forwarded to the AF. After responding to the AF, the AMF decides if the device's context should be deleted. If so, the AMF may send a de-registration notification to the AIoT device and/or AF, terminating the device's connection to the network.

### BACKGROUND

An ambient power-enabled IoT (AIoT) device is a kind of IoT device that can harvest energy from the environment, such as wireless radio waves, motion, vibration, piezoelectricity, solar and wind power, etc. They are either battery-less or have limited energy storage (e.g., using a capacitor). Ambient power-enabled IoT devices often find their usage in Industrial Wireless Sensor Networks where the environment is harsh (e.g., extremely high or low temperature) and requires devices to be battery-less, maintenance-free, and long service life. They will also play an important role in Smart Logistics and Smart Warehousing. The low cost, small form factor, battery-lessness, and durability make them suitable to be attached to huge amounts of goods and facilitate more efficient goods identifying, sorting, tracking, and inventory. In typical Ambient power-enabled IoT use cases, AIoT devices are most likely involved in very small size data transmission/reception, such as sending device identifications, product information, sensor data, or receiving actuator commands, triggering messages, etc.

The following two topologies are considered: (1) a topology where the AIoT Device connects directly to the based station, and (2) a topology where the Ambient IoT Device connects communicates with the base station via an intermediate node. In both topologies, there is a need for processes by which an AMF may maintain or delete AIoT device context information when it is no longer needed.

### SUMMARY

Disclosed are method and apparatus for creating, maintaining, and purging an AIoT device context at an AMF. The method begins with the Access and Mobility Management Function (AMF) receiving an Application Function (AF) inventory request message from an AF, which identifies the Ambient IoT (AIoT) device and includes context preservation guidance information. Following this, the AMF retrieves the necessary subscription information for the identified AIoT device. The AMF then notifies the AIoT device that it is the serving node responsible for managing the device. The AMF creates and stores context information related to the AIoT device to manage its connectivity and mobility within the network. To further process the inventory request, the AMF sends an inventory request message to the AIoT device via a base station, and subsequently receives an inventory response message from the AIoT device, which is relayed to the AF in an AF inventory response message. After responding to the AF, the AMF determines whether to delete the context information of the AIoT device. If the context is to be deleted, a de-registration notification may be sent to the AIoT device, and/or the AF, effectively terminating AIoT device's connection with the network.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 is a system diagram of a communication system involving AIoT devices;

FIG. 3 shows an example procedure for creating, maintaining; and purging AIoT device context information;

FIG. 4 shows an example procedure for maintaining an AIoT device context at an AMF; and

FIG. 5 shows an example process for performing an context preservation check procedure involving an AMF and AIoT device.

### DETAILED DESCRIPTION

The following acronyms are used throughout the application and should be understood as defined below unless separately defined in a different part of the application.
AIoT Ambient-power enabled
AF Application Function
AMF Access and Mobility Management Function
AIoT Ambient IoT device
BS Base Station
HSS Home Subscriber Server
MME Mobility Management Entity
NEF Network Exposure Function
NF Network Function
PCF Policy Control Function
SGSN Serving GPRS Support Node
R-19 Release-19
RAN Radio Access Network
RRC Radio Resource Control
SUCI Subscriber Concealed Identifier
UDM Unified Data Management
UDR Unified Data Repository

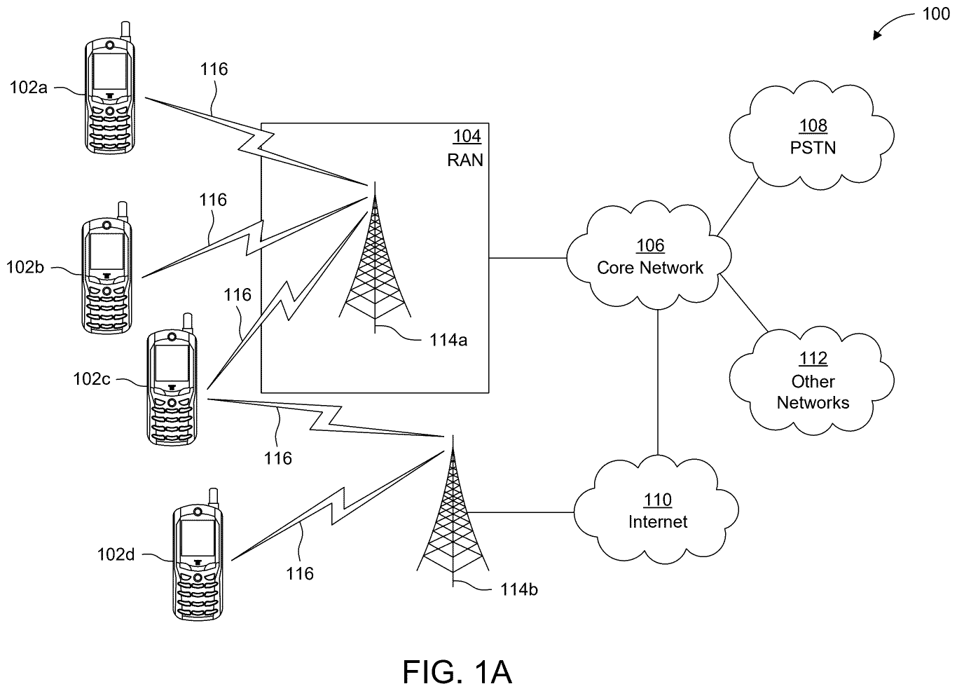

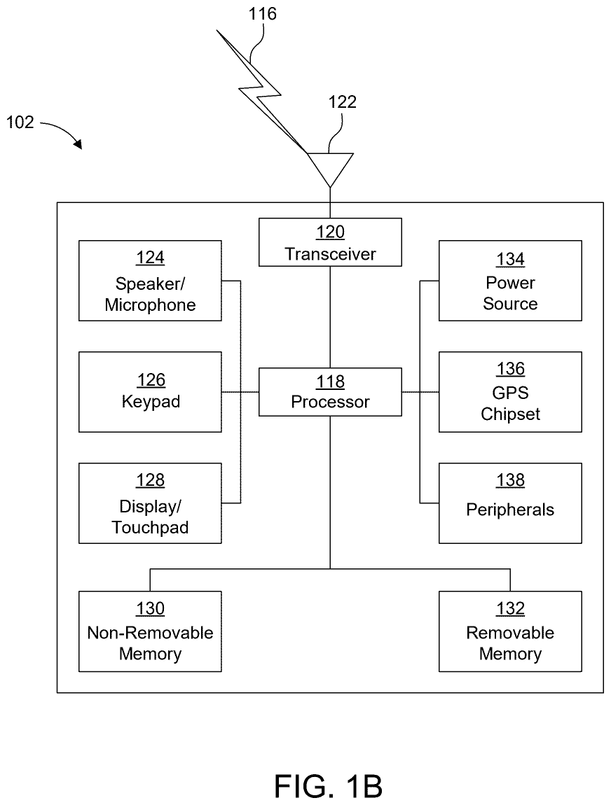

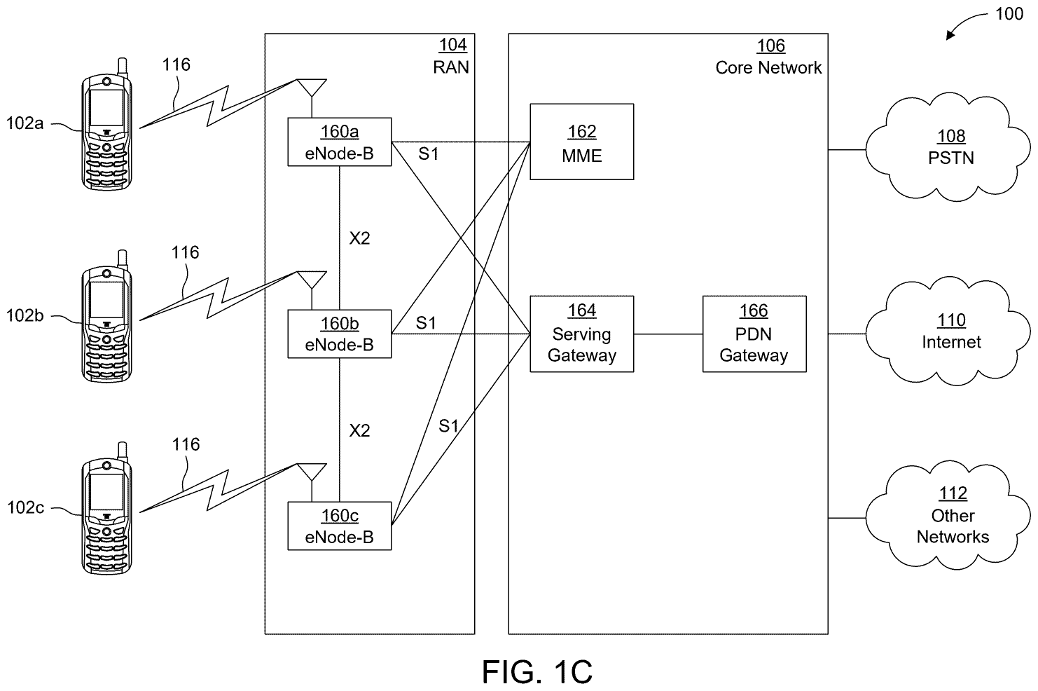

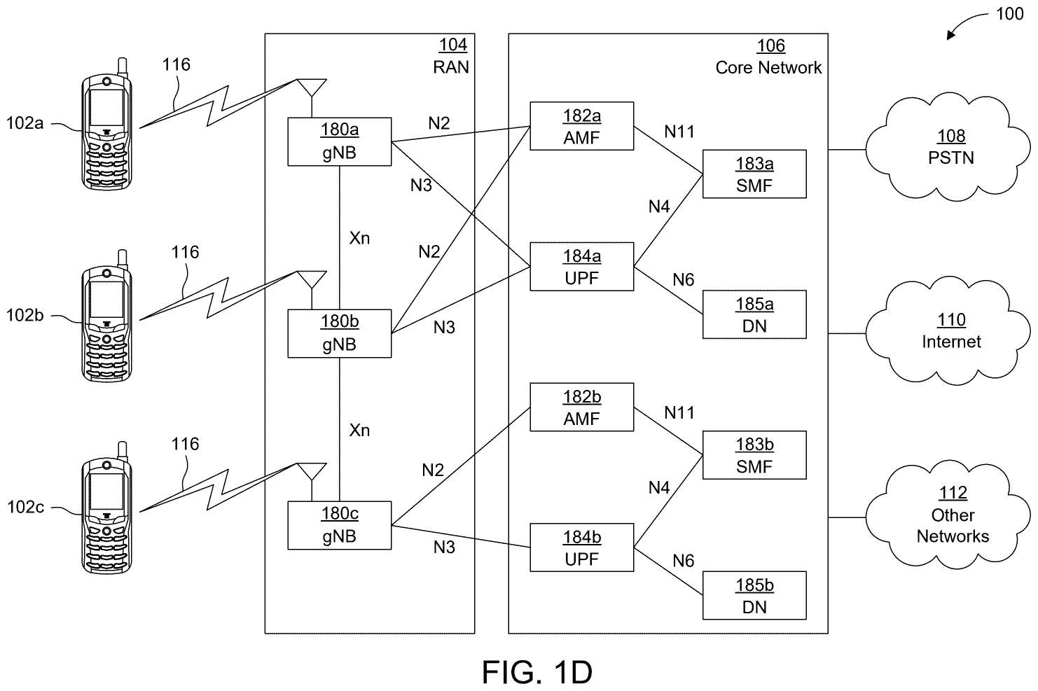

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, Ambient-power enabled IoT (AIoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), an access node (AN), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc”mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80 +80 configuration. For the 80 +80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80 +80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a,184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Herein, the terms, device, Ambient IoT Device, WTRU, and UE may be used interchangeably. The terms AIoT Controller and AMF may be used interchangeably.

Embodiments herein describe actions that can be taken by an AMF. The actions that are described as being performed by the AMF may alternatively be performed by an AIoT Controller. The AIoT Controller may be collocated with the AMF or the functionality of the AMF is extended to include the functionality of the AIoT Controller.

Embodiments herein describe actions that can be taken by an NEF. The actions that are described as being performed by the NEF may alternatively be performed by an AIoT Controller.

Purging context of a device is a process where a service node determines that it no longer serves a device, deletes or invalidates the AIoT device's context from a storage location that is associated with the service node, and informs a subscription data base that the serving node no longer serves the device. An AIoT Controller, AMF, MME, and SGSN are examples of serving nodes. A UE, a WTRU, and an AIoT Device are examples of devices. The terms A-RAN, RAN Node, AN, gNodeB, Base Station, and Reader may be used interchangeably herein.

Embodiments and actions that are described herein as taking place in the AIoT Controller can take place in any serving node.

Subscription data, AIoT device state information, security information, AIoT device capability information, Mobility and session management context information and AIoT device identities are examples of AIoT device context information, or WTRU context information. Security context information of a AIoT device is an example of AIoT device context information. Security context information can include temporary identifiers that are assigned to the AIoT device and security keys that are associated with the AIoT device.

Serving node information includes the identity of the AIoT device's current Serving Node. Location context information of a AIoT device is an example of AIoT device context information. Location context information may include the UE's last known location. The AIoT device's last known location may be represented as a set of coordinates, or the identity of the last access node that the AIoT device communicated with.

Inventory procedure description and considerations are discussed here. The inventory procedure is one of the introduced procedures that are used with Ambient IoT devices. When the AIoT device is attached to specific assets or facilities, the network might probe these devices through specific readers to obtain certain information such as location, asset status, reporting data, etc. The readers might be an intermediate node (e.g., UE or WTRU) or RAN node. Typically, the exchange in the inventory procedure is a limited amount of data in both directions. Many inventory use cases are introduced and described in wireless standards.

Several assumption should be noted with respect to the architecture described herein. Two traffic types may be possible, device-terminated (DT), and device-originated—device terminated (DO-DTT). Two connectivity topologies may be defined: Topology 1 in which a base station and the AIoT device communicate directly; and Topology 2, in which a base station and the AIoT device are communicate through an intermediate node. In Topology 2, only a UE or WTRU can act as an intermediate node that is under control of the network. In some cases the communication spectrum may be licensed spectrum. There is no handover supported by AIoT networks, and RRC states are not supported by AIoT devices. Further, in some cases there is no mobility supported by AIoT devices (i.e. no cell selection/re-selection-like function).

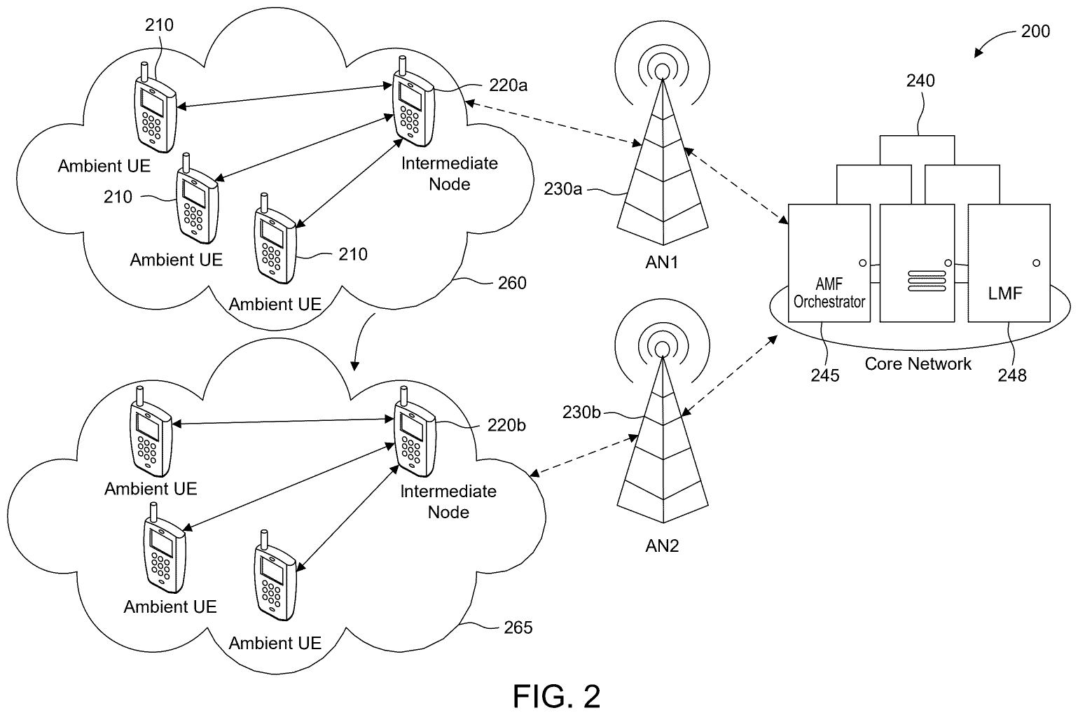

FIG. 2 illustrates a communication system involving Ambient IoT devices or User Equipment (UE) 210, Intermediate Nodes, 220a, 220b, Access Nodes (AN1 230a and AN2 230b), and a Core Network 240. The AIoT devices or UEs 210 are devices within two different clusters 260, 265, connected through Intermediate Nodes 220a and 220b respectively, which relay their data to the Access Nodes (AN1 230a and AN2 230b). Each Access Node 230a, 230b, acts as a link between the Intermediate Nodes 220a, 220b, and the Core Network 240. The Core Network 240, includes components such as the AMF Orchestrator 245 and LMF 248, which are responsible for authentication, management, and location services. The diagram demonstrates an example of Topology 2, in which a base station and the AIoT device are communicate through an intermediate node that is a UE or WTRU.

More specifically, FIG. 2 shows a scenario 200 where the network is using an intermediate node 220a, 220b to locate and page an AIoT device(s) (UE(s) 210). The network might use the intermediate nodes 220a, 220b, which may be another UE, to locate an AIoT device 210 due to the limited power availability in the AIoT device and the possibility of the AIoT device becoming deactivated when the AIoT device runs out of power. When the AIoT device becomes not pageable, the network can use the intermediate node UE 220a, 220b, location to locate the AIoT device. An Intermediate node 220a, 220b may interface to an AIoT device 210 in the same way that an AIoT device interfaces with a Base Station, or access node such as AN1 230a, or AN2 230b. It should be noted that the AIoT device 210 may be stationary, or may move between the different intermediate node UEs 220a, 220b, as is shown by the arrow.

In 5G, there may be certain triggers that lead the network to purge an AIoT device's context from the serving node's storage (i.e. the AMF's storage). For example, completion of a deregistration procedure will be used by the AMF to detect that it is no longer serving the AIoT device and cause the AMF to purge the AIoT device's context from storage and inform the UDM/UDR that the AMF is no longer serving the UE. The AMF may determine to implicitly deregister the AIoT device because the AIoT device has not contacted the network for a period of time (i.e. the AIoT device's periodic registration timer has expired). When the AMF decides to implicitly deregister the AIoT device, the AMF will purge the WTRU's context from storage and inform the UDM/UDR that the AMF is no longer serving the AIoT device.

A serving node in an Ambient IoT network, such as an AIoT Function or AMF, may serve a relatively large number of AIoT Devices. The serving node may store context that is associated with AIoT device. Examples of context information include security context, temporary identifiers of the device, device location, identifier of the Reader, AIoT device reports, historic data on the AIoT devices etc.

An Ambient IoT serving node cannot rely on the same triggers as a 5G serving node for detecting when it is possible to purge AIoT device context. For example, Ambient IoT device might not have reliable power sources and therefore it cannot be assumed that Ambient IoT devices can reliably perform periodic procedures (e.g. registration) and it cannot be assumed that Ambient IoT device will be able to initiate a de-registration procedure when the Ambient IoT device will not be available.

System enhancements are desired to enable the AMF to detect when it is proper to purge AIoT Device Context and to avoid purging devices that will soon need to be served by the AMF. These enhancements are needed to avoid excessive overhead of maintaining a large number of contexts for devices that may or may not be reachable or active. It is also desirable to determine whether further inventory/command service will be required for a device or whether a device is no longer active.

The embodiments herein describe how a AIoT serving node, AMF for example, can be configured by an AF to determine when the serving node can delete WTRU context. The configuration can be based on time, the WTRU's location, and the number of messages that are sent by the WTRU.

Once the serving node determines to delete, or purge, the WTRU's context, the serving node can initiate procedures with the WTRU and/or AF to check if it is appropriate and still desired for the serving node to stop serving the WTRU and delete the WTRU's context.

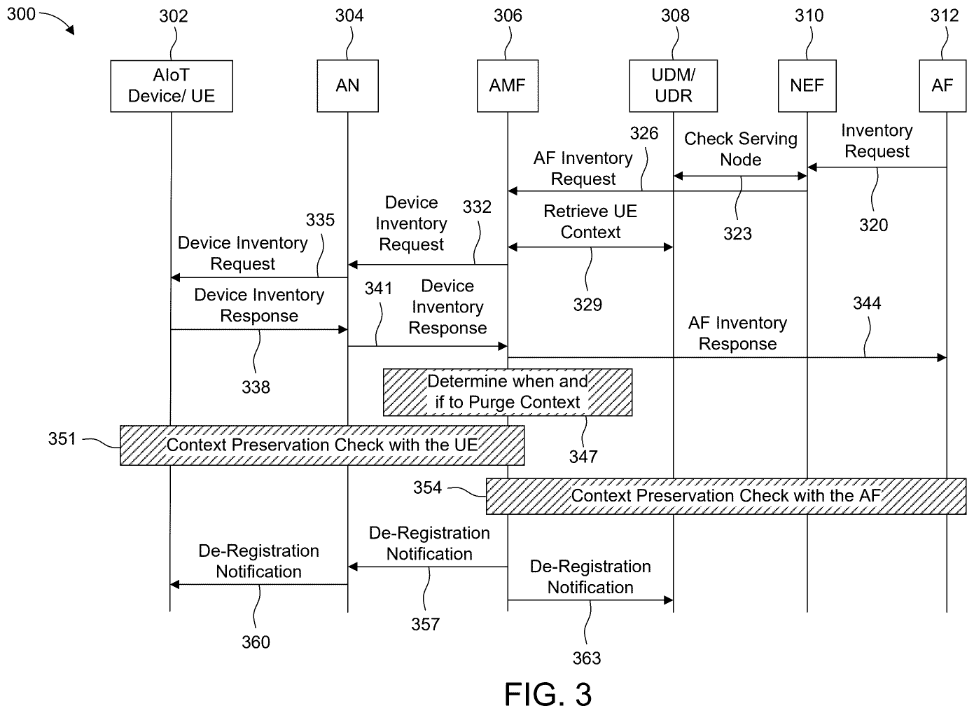

FIG. 3 shows an example procedure, 300, for the interaction between various network components such as the AIoT Device/WTRU 302, Access Node (AN) 304, Access and Mobility Management Function (AMF) 306, Unified Data Management/Unified Data Repository (UDM/UDR) 308, Network Exposure Function (NEF) 310, and Application Function (AF) 312. The sequence flow in FIG. 3 outlines the process of WTRU inventory and context preservation, as well as registration and de-registration of WTRU.

Inventory Request (AF to NEF): The process begins with the AF 312 sending an inventory request to the NEF 310, at 320.

Check Serving Node (NEF to UDM/UDR): NEF 310 checks the AIoT device's 302 serving node status from UDM/UDR 308, at 323.

AF Inventory Request (NEF to AMF): The NEF 310 forwards the inventory request to the AMF 306, at 326.

Retrieve UE Context (UDM/UDR to AMF): The AMF 306 retrieves the AIoT device's 302 context from UDM/UDR 308, at 329.

Inventory Request (AMF to AN): The AMF 306 sends an inventory request to the AN 304, at 332.

Inventory Request (AN to UE): The AN 304 forwards the inventory request to the AIoT device 302, at 335.

Inventory Response (UE to AN): The AIoT device 302 responds with its inventory details back to the AN 304, at 338.

Inventory Response (AN to AMF): The AN 304 sends the inventory response to the AMF 306, at 341.

AF Inventory Response (AMF to NEF): The AMF 306 forwards the inventory response to the NEF 310, which sends it to the AF 312, at 344.

AMF 306 may perform a determination of when and if to purge the AIoT device's 302 context, at 347.

Context Preservation Check-ins (AMF to UE & AF): The AMF 306 may also perform context preservation check-ins with both the AIoT device 302, at 351, and with the AF 312, at 354, to determine when and how to trigger context preservation.

De-Registration Notifications: If the AIoT device 302 is to be de-registered, notifications are sent from the AMF 306 to the AN 304, at 357, and from the AN 304 to the AIoT device 302, at 360. De-Registration notifications may also be sent from the AMF 306 to the UDM/UDR 308, at 363.

A more detailed discussion of FIG. 2 follows herein. At 320, an AF 312 sends an inventory request to the AMF 306 via the NEF 310. The inventory request may include at least one of: the targeted AIoT device's identity and/or type, requested data, application-ID, or the application-type.

The inventory request from the AF 312 may also include context preservation guidance information. Context preservation guidance information can include any one of or combination of the following pieces of information (A)-(H):
(A) An indication that the serving node (e.g. AMF) does not need to preserve the AIoT device's context after the AIoT device responds to the inventory request;
(B) An indication that the serving node (e.g. AMF) does not need to preserve the AIoT device's context after the inventory request is sent to the AIoT device;
(C) An indication that the serving node (e.g. AMF) does not need to preserve the AIoT device's context after a certain number of inventory request messages that have been sent to the AIoT device and a number of expected requests;
(D) An indication that the serving node (e.g. AMF) does not need to preserve the AIoT device's context after a certain number of inventory response messages have that been received from the AIoT device and a number of expected responses;
(E) An indication that the serving node (e.g. AMF) does not need to preserve the AIoT device's context after a certain number of inventory attempts to reach the AIoT device have failed (i.e., without receiving any response);
(F) An indication that the serving node (e.g. AMF) should preserve AIoT device's context until the serving node receives a request that indicates that the context should be deleted (e.g. a notification that a different node is serving the AIoT device or a notification from the AIoT device);
(G) A context preservation time duration that represents how long the AMF is recommended to preserve AIoT device's context after the last successful AIoT procedure (i.e., Inventory, command or inventory+command); and
(H) A geographical area that that can be used to trigger deletion of the AIoT device's context (i.e. when the AIoT device leaves the geographical area).

Alternatively, the Context Preservation Guidance Information as described above may be locally configured in the serving node.

Alternatively, the serving node may retrieve the Context Preservation Guidance Information from a network policy server (e.g., PCF) (not shown).

The AF-provided or locally configured Context Preservation Guidance Information may be for a specific AIoT device or a group of AIoT devices, or all the AIoT devices that are served by the serving node.

The inventory request from the AF can also include expected AIoT device location(s). The expected AIoT device location(s) can be used in an AMF Selection procedure.

The scenario where the Context preservation guidance information includes an indication that the serving node (e.g. AMF) does not need to preserve the UE's context after the inventory request is sent to the UE, may be useful in a scenario where the AMF is able to route responses from an AIoT Devices to the correct AF without having been the AMF that transmitted a request to the AIoT Device.

At 323, the NEF 310 will query the UDM/UDR 308 to check if there is an AMF that is already serving the AIoT device 302. In other words, the NEF 310 will query the UDM/UDR 308 to check if there is an AMF that already has context stored for the AIoT device 302. The UDM/UDR 308 may respond with the identity of an AMF that is currently serving the AIoT device 302. The UDM/UDR 308 may respond with an indication no AMF is currently serving the AIoT device 302. The UDM/UDR 308 may respond with AMF selection assistance information. The AMF selection assistance information can include information about the expected geographical location of the AIoT device. The expected geographical location of the AIoT device can be based on expected AIoT device trajectory information that was previously stored in the AIoT device's subscription information in the UDM/UDR 308. The AMF selection assistance information can include the identities of the AMFs that serve the AIoT device's expected location.

At 326, the NEF 308 might perform an AMF selection procedure and forward the inventory request from the AF 312 to the selected AMF 306. If the UDM/UDR 308 indicated in 323 that an AMF is currently serving the AIoT device 302, then the NEF 308 will select the AMF 306 that is currently serving the AIoT device 302.

If the UDM/UDR 308 indicated at 323 that no AMF is currently serving the AIoT device 302, then the NEF 310 may select AMF based on the AMF Selection Assistance Information and the expected AIoT device location information that was provided by the AF 312 in step 320. For example, the NEF 310 may be provisioned with the identities of AMFs that serve certain location and the NEF 310 may select an AMF that is likely to serve the AIoT device's 302 current location.

At 329, reception of the inventory request may trigger the AMF 306 to check if it has any context information stored for the AIoT device 302. If the AMF 306 does not have any context information stored for the AIoT device 302, the AMF 306 may send a request to the UDM/UDR 308 for context information about the AIoT device 302. The AMF 306 will receive the context information from the UDM/UDR 308. AIoT device context information might include, state information, security information, capability information and the identities of the AIoT device.

The UDM/UDR 308 may provide the AMF 306 with the AMF 306 that most recently served the AIoT device so that the AMF 306 can get the AIoT device's context from the AMF 306 that most recently served the AIoT device.

If the AMF 306 does have context information stored for the AIoT device, the AMF 306 will not need to send a request to the UDM/UDR 308 for context information.

The AMF 306 may notify the UDM/UDR 308 that is now serving the AIoT device. The AMF serving the AIoT device means that the AMF is storing context information for the AIoT device. The AMF stores the received context preservation guidance information in the inventory request.

At 332 the AMF 306 sends an inventory message to the AN 304 (Ambient IoT RAN node which could be a BS reader or Intermediate UE reader). The message might have the request content, AIoT device identity, Application-type and Application-ID. The message might also include the context preservation guidance information.

At 335, the AN 304 sends the inventory request message to the AIoT device 302. The message might have the request content, AIoT device identity, Application type and Application-ID. The message might also include the request characteristics as well.

At 338, upon receiving the request, the AIoT device 302 responds to the Inventory request. The inventory response message might have the response content, AIoT device-ID, Application type and Application-ID and AIoT device location information.

At 341, the AN 304 forwards the inventory response message to the AMF306. In this step, the AMF 306 may run a timer while waiting to receive the inventory response. The AMF 306 may use the timer to detect that it has been waiting for a duration of time and, once it has waited a duration of time, the AMF 306 may determine that AIoT device 302 has not, will not, or is unlikely to respond to inventory request message. Once the AMF 306 determines that the AIoT device 302 has not responded, the AMF 306 may increment a inventory request attempt counter that is associated with the device. The duration of time may be based on information that was received in the context preservation guidance information or based on local AMF configuration.

If a response is received, the AMF 306 may proceed to 344. If no response is received, and if the inventory request attempt counter is not yet equal to the number of attempts value that was received in the context preservation guidance information, then the AMF 306 may attempt step 332 again by sending an inventory request message to the AN 304. If no response is received, and if the inventory request attempt counter is equal to the number of attempts value that was received in the context preservation guidance information, then the AMF may proceed to step 9344.

At 344, the AMF 306 forwards the inventory response message to the AF 312. If no inventory response message is received at 341, then the inventory response message that is sent to the AF 312 may include an indication that no inventory response message was received and also indicate how many inventory requests the AMF 306 attempted.

If an inventory response message is received at 341, then the inventory response message that is sent to the AF 312 may include the information that was received in the inventory response and also indicate how many inventory requests the AMF 306 attempted.

At 347, the AMF 306 may begin to perform steps to determine when to delete, or purge, the AIoT device's context. In this step, the AMF 306 may determine to delete the AIoT device's context based on receiving an indication in at 326 that the serving node (e.g. AMF) does not need to preserve the AIoT device's context after the AIoT device 302 responds to the inventory request. Thus, reception of the Inventory Response (341) may trigger the AMF 306 to delete the AIoT device's context and proceed to 357.

Also at 347, the AMF 306 may determine to delete the AIoT device's context based on receiving an indication in 326 that the serving node (e.g. AMF) does not need to preserve the AIoT device's context after the inventory request is sent to the AIoT device 302. Thus, transmission of the Inventory Request (332) may trigger the AMF 306 to delete the AIoT device's context and proceed to 357.

Also at 347, the AMF 306 may increment a counter that counts the number of inventory requests messages that have been sent to the AIoT device 302. In other words, the counter may be incremented based on transmission of inventory request message (332). The AMF 306 may compare the counter value to the number of expected requests value that was received in the inventory Request of 326. The comparison may cause the AMF 306 to determine that the expected number of requests have been sent, may trigger the AMF 306 to delete the AIoT device's context and proceed to 357.

Also at 347, the AMF 306 may increment a counter that counts the number of inventory response messages that have been received from the AIoT device 302. In other words, the counter may be incremented based on reception of inventory response message (341). The AMF 306 may compare the counter value to the number of expected responses value that was received in the inventory request at 326 . The comparison may cause the AMF 306 to determine that the expected number of responses that have been received, may trigger the AMF 306 to delete the AIoT device's context and proceed to 357.

Also at 347, the AMF 306 may determine to store context until it receives a request that indicates that the context should be deleted (e.g. a notification that a different node is serving the AIoT device 302). Reception of a notification from the UDM/UDR 308 or a different AMF that indicates that a different node is serving the AIoT device 302 may trigger the AMF 306 to delete the AIoT device's context and proceed to 357.

Also at 347, the AMF 302 may compare a timer value to the context preservation time duration that was received in 326. The comparison may cause the AMF 302 to determine that it has been storing the AIoT device's context longer than the context preservation time duration that was received in 326. This determination may trigger the AMF 306 to delete the AIoT device's context and proceed to 357. For example, the AMF 302 may detect that the AIoT device 302 is not in the geographical area based on the an AN,304 which is not serving geographical area, sending a message from the AIoT device 302 to the AMF 306.

When the AMF 306 determines that it might be time to delete the AIoT device's context, the AMF 306 may perform a procedure with the AIoT device 302 to check if context deletion is appropriate. For example, at 351, the AMF 306 may send a context deletion request to the AIoT device 302. The AMF 306 may decide to only delete the AIoT device's context if the AIoT device 302 does not respond or if the AIoT device 302 sends a response to the AMF that indicates that it is ok to delete the AIoT device's context. For example, reception of a response may be indicative of the AIoT device 302 still being in the AMF's service area and therefore it is appropriate for the AMF 306 to continue to serve the AIoT device 302. For example, reception of NO response may be indicative of the AIoT device no longer being in the AMF's service area and therefore it is appropriate for the AMF 306 to stop serving the AIoT device 302. If the AMF 306 decides to stop serving the AIoT device 302 and delete the AIoT device's context, the AMF 306 may continue to 357. If the AMF 306 decides to continue serving the AIoT device's, the AMF 306 may run a timer (e.g. based on the context preservation time) and, upon expiration of the timer, repeat step 351 to check again if AIoT device's context should be deleted.

Optionally the procedure 351 may involve the AMF 306 requesting that one or more AN(s) broadcast a context purge warning message. The context purge warning message may include an identity of the AIoT device 302 and may serve as a warning message to the AIoT device 302 that the AMF 306 will purge the AIoT device's context and stop serving the UE AIoT device 302 if no message is received from the AIoT device 302 by AMF 306 within a time period. This warning message could be sent to multiple AIoT devices (group of UE's) being served by the AN(s), wherein the warning message would include indication that it applies to group of devices identified by group identifier. The message from the AMF 306 to the AN 304 may include the time period and the message that is broadcasted by the AN 304 may include the AIoT device's Identity and time period. Upon reception of the warning message, the AIoT device 302 may determine that it should send a message to the AMF 306 so that the AMF 306 knows that the AIot device 302 is still in the AMF's serving area and so that the AMF 306 will continue to serve the AIoT device 302 and not delete the AIoT device's context information.

When the AMF 306 determines that it may be time to delete the AIoT device's context, the AMF 306 may perform a procedure with the AF 312 to check if context deletion is appropriate. For example, as shown at 354, the AMF 306 may send a context deletion request to the AF 312. The AMF 306 may decide to only delete the AIoT device's context if the AF 312 sends a response to the AMF 306 that indicates that it is ok to delete the AF's context. The AMF 306 may decide to delete the AIoT device's context only if the AF 312 sends a response that indicates that it is ok for the AMF 306 to stop serving the AIoT device 302. If the AMF 306 decides to stop serving the AIoT device 302 and delete AIoT device's context, the AMF 306 may continue to 357. If the AMF 306 decides to continue serving the AIoT device 302, the AMF 306 may run a timer (e.g. based on the context preservation time) and, upon expiration of the timer, repeat 354 to check again if AIoT device's context should be deleted.

As an alternative to running a timer for each device, the AMF 306 may run a timer for a group of AIoT devices. Each context may be timestamped with “last seen” activity (inventory/command) or “preservation” time. The timer can be used to trigger deletion of older contexts with inactivity time or preservation time higher than a certain threshold. “Older contexts” refer to context that are associated with an inactivity time that is higher than a threshold. The threshold can be based on the context preservation guidance information based on local operator policy. For example, the AF 312 may provide different context preservation guidance information for different types of devices or groups of devices.

As an alternative to running a timer for each device, the AMF 306 may run a timer for a group of AIoT devices. Each context may be timestamped with “last seen” activity (inventory/command) or “preservation” time. The timer can be used to trigger deletion of older contexts with inactivity time or preservation time higher than a certain threshold. “Older contexts” refer to context that are associated with an inactivity time that is higher than a threshold. The threshold can be based on the context preservation guidance information based on local operator policy. For example, the AF 312 may provide different context preservation guidance information for different types of devices or groups of devices.

At 357, based on the determination to delete the AIoT device's context, the AMF 306 may send a de-registration notification to the AIoT device 302 via the AN 304.

At 360, the AN 304 may forward the de-registration notification to the AIoT device 302. Reception of the de-registration notification will trigger the AIoT device to delete any context that it has stored for communicating with the AMF 306. For example, the AIoT device 302 may delete any temporary identifiers that were assigned to the AIoT device by the AMF 306. Furthermore, the AIoT device 302 may delete the AMF's identity from any local storage in the AIoT device.

At 363, based on the determination to delete the AIoT device's context, the AMF 306 will send a de-registration notification to the UDM/UDR 308. The de-registration notification to the UDM/UDR 308 serves as a notification to the UDM/UDR 308 that the AMF 306 is no longer serving the AIoT device 302. Thus, the UDM/UDR 308 will update any context that the UDM/UDR 308 has stored for the AIoT device 302 to indicate that the AMF 306 is not serving the AIoT device 302 or that no AMF is serving the AIoT device 302.

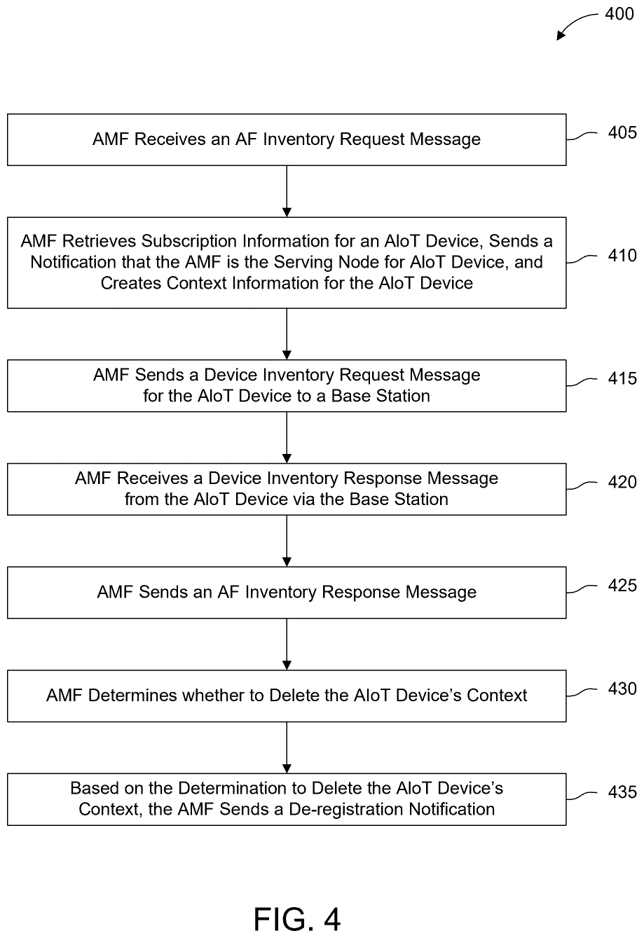

FIG. 4 shows a flow diagram for processing 400 maintaining an AIoT device context at an AMF. The process begins when the AMF receives an AF inventory request message at 405. The retrieves the subscription information for the AIoT device, sends a notification indicating that the AMF is now the serving node for the AIoT device and creates context information for the AIoT device, at 410. The AMF sends an inventory request message to the AIoT device via a base station, requesting details from the AIoT device, at 415. The AMF receives an inventory response message from the AIoT device via the base station, which provides the requested details, at 420. The AMF sends an inventory response message back to the AF, completing the inventory process, at 425. Next, the AMF determines whether the AIoT device's context should be deleted, at 430. If the determination is made to delete the AIoT device's context, the AMF may send a de-registration notification and delete the AIoT device's context, at 435.

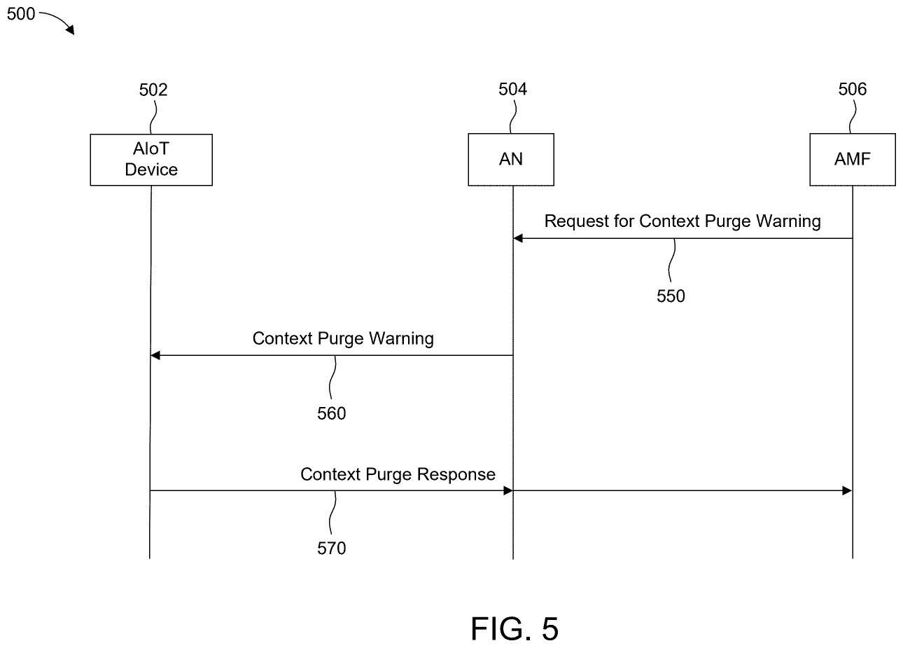

FIG. 5 illustrates a process 500 for performing context preservation check procedure between an AMF 506, and an AIoT device 502, via an AN 504. This process is an example of the process noted in element 351 in FIG. 3.

At 550, the AMF 506 sends a request for a context purge warning to the AN 504. This initiates the process to prepare for the potential removal of the AIoT device's context. At 560, the AN 504 forwards the context purge warning to the AIoT device 502, notifying it that its context information may be purged. At 570, the AIoT device 502 sends a message to the AMF 506 to inform the AMF that the AIoT device is still in the AMF's serving area. This will enable the AMF 506 to continue to serve the AIoT device 502, and not delete the AIoT device's context. The message at 570 may be sent by the AIoT device based on a determination that the AIoT device is still in the AMF's serving area.

Optionally, the context purge warning message may include the identity of the AIoT device and may serve as a warning message that the AMF will purge the AIoT device's context if no message is received from the AIoT device. The context purge warning message may also include a time period during which a response must be received by the AMF, or the AMF will purge the AIoT device's context. The context purge warning message may apply to a group of AIoT device's, using a group identifier, or to a single AIoT device.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

What is claimed:

1. A method performed by an access and mobility management function (AMF) for maintaining a Ambient IoT (AIoT) device context, the method comprising:
receiving an application function (AF) inventory request message that identifies an AIoT device for an inventory request, and includes context preservation guidance information;
retrieving subscription information for the identified AIoT device;
sending a notification that the AMF is a serving node for the identified AIoT device;
creating context information for the identified AIoT device and storing the context information at the AMF;
sending a device inventory request message to the identified AIoT device via a base station;
receiving a device inventory response message from the identified AIoT device via the base station;
sending an application function (AF) inventory response message in response to the device inventory response message;
determining to delete the context information of the identified AIoT device in response to sending the AF inventory response message; and
sending a de-registration notification to the identified AIoT device.

2. The method of claim 1, wherein the determining to delete the context information of the identified AIoT device is based on receiving an indication in the context preservation guidance information that indicates that the AMF does not need to preserve the context information of the indicated AIoT device after the indicated AIoT device responds to the inventory request.

3. The method of claim 1, wherein the determining to delete the context information of the identified AIoT device is based on receiving a notification that a different AMF is the serving node for the identified AIoT device.

4. The method of claim 1, wherein the determining to delete the context information of the identified AIoT device is based on sending a context deletion warning to the identified AIoT device and receiving an indication that the context information of the identified AIoT device can be deleted.

5. The method of claim 1, wherein the determining to delete the context information of the identified AIoT device is based on sending a context deletion warning to the identified AIoT device and not receiving a response from the identified AIoT device.

6. The method of claim 1, wherein the determining to delete the context information of the identified AIoT device is based on a determination that the identified AIoT device is not in a geographical area that was provided to the AMF.

7. The method of claim 1, wherein the determining to delete the context information of the identified AIoT device is based on the AMF performing an context preservation check procedure with the identified AIoT device.

8. The method of claim 1, wherein the determining to delete the context information of the identified AIoT device is based on the AMF performing an context preservation check procedure with the AF.

9. The method of claim 1, further comprising: sending the de-registration notification to a Unified Data Management/unified data repository (UDM/UDR).

10. The method of claim 1, wherein a content of the device inventory request message is based on content of the AF inventory request message.

11. A access and mobility management function (AMF) configured to maintain an Ambient IoT (AIoT) device context, the AMF comprising:
a processor;
a memory; and
a transceiver, wherein the processor, memory, and transceiver are configured to:
receive an application function (AF) inventory request message that identifies an AIoT device for an inventory request, and includes context preservation guidance information;
retrieve subscription information for the identified AIoT device;
send a notification that the AMF is a serving node for the identified AIoT device;
create context information for the identified AIoT device and store the context information in the memory;
send a device inventory request message to the identified AIoT device via a base station;
receive a device inventory response message from the identified AIoT device via the base station;
send an application function (AF) inventory response message in response to the device inventory response message;
determine to delete the context information of the identified AIoT device in response to sending the AF inventory response message; and
send a de-registration notification to the identified AIoT device.

12. The method of claim 11, wherein the processor, memory, and transceiver are configured to: delete the context information of the identified AIoT device based on receiving an indication in the context preservation guidance information that indicates that the AMF does not need to preserve the context information of the indicated AIoT device after the indicated AIoT device responds to the inventory request.

13. The method of claim 11, wherein the processor, memory, and transceiver are configured to: delete the context information of the identified AIoT device based on receiving a notification that a different AMF is the serving node for the identified AIoT device.

14. The method of claim 11, wherein the processor, memory, and transceiver are configured to: delete the context information of the identified AIoT device based on sending a context deletion warning to the identified AIoT device and receiving an indication that the context information of the identified AIoT device can be deleted.

15. The method of claim 11, wherein the processor, memory, and transceiver are configured to: delete the context information of the identified AIoT device based on sending a context deletion warning to the identified AIoT device and not receiving a response from the identified AIoT device.

16. The method of claim 11, wherein the processor, memory, and transceiver are configured to: delete the context information of the identified AIoT device based on a determination that the identified AIoT device is not in a geographical area that was provided to the AMF.

17. The method of claim 11, wherein the processor, memory, and transceiver are configured to: delete the context information of the identified AIoT device based on the AMF performing an context preservation check procedure with the identified AIoT device.

18. The method of claim 11, wherein the processor, memory, and transceiver are configured to: delete the context information of the identified AIoT device based on the AMF performing an context preservation check procedure with the AF.

19. The method of claim 11, wherein the processor, memory, and transceiver are configured to: send the de-registration notification to a Unified Data Management/unified data repository (UDM/UDR).

20. The method of claim 11, wherein a content of the device inventory request message is based on content of the AF inventory request message.
